(19) United States
(12) Patent Application Publication
(10) Pub. No.: US 2026/0191142 A1
(43) Pub. Date: Jul. 9, 2026

(54) AUTONOMOUS ROBOTIC FRUIT HARVESTING VEHICLE

(71) Applicant: Raviraj Suhas Chilka, New York, NY (US)

(72) Inventor: Raviraj Suhas Chilka, New York, NY (US)

(21) Appl. No.: 19/441,004

(22) Filed: Jan. 6, 2026

Related U.S. Application Data
(60) Provisional application No. 63/742,241, filed on Jan. 6, 2025.

(51) Int. Cl. A01D 46/30; A01D 46/253; B25J 5/00; B25J 9/00; B25J 9/10; B25J 9/16; B25J 17/02; B65G 11/10; B66F 3/22; G05D 1/248; G06V 20/56; G06V 20/68

(52) U.S. Cl. CPC A01D 46/30; A01D 46/253; B25J 5/007; B25J 9/0027; B25J 9/102; B25J 9/1605; B25J 9/163; B25J 9/1697; B25J 17/0241; B65G 11/103; B66F 3/22; G05D 1/248; G06V 20/56; G06V 20/68; B65G 2201/0211; B65G 2203/0233; B65G 2203/0241

(57) ABSTRACT

Apparatus and associated methods relate to a robot with a multi-axis end effector configured to operate produce into a collection guideway that is separate from the end effector. In an illustrative example, an end effector may include a rotating device configured to rotate the end effector about a longitudinal axis. The rotating device may, for example, be actuated by a linear actuator. The linear actuator may, for example, be operably coupled to a vacuum pump. The vacuum pump may, for example, produce a negative pressure within the end effector. The negative pressure within the end effector may, for example, join a produce to the end effector. The end effector may, for example, deposit the produce in the guideway. The guideway may, for example, be coupled to a container. Various embodiments may, for example, advantageously enable the robot to harvest produce to a container with few movements.

### CROSS-REFERENCE TO RELATED APPLICATIONS

This application is a non-provisional application and claims the benefit of U.S. Application Ser. No. 63/742,241, titled “AUTONOMOUS ROBOTIC FRUIT HARVESTING VEHICLE,” filed by Raviraj Suhas Chilka on Jan. 6, 2025.

This application incorporates the entire contents of the foregoing application(s) herein by reference.

### TECHNICAL FIELD

Various embodiments relate generally to an agricultural harvesting device.

### BACKGROUND

Produce farms play a role in global agriculture by providing food sources that contribute to a balanced diet. These farms range in scale from small family-owned operations to large commercial enterprises that supply markets worldwide. Produce such as apples, oranges, eggplants, peppers, tomatoes, cucumbers, zucchini, pears, plums, cherries, peaches, apricots, figs, pomegranates, persimmons and many more are cultivated using both traditional methods and modern technologies.

Proper harvesting ensures the produce reaches its peak ripeness, optimizing taste, nutritional content, and shelf life. Timely harvesting helps farmers increase their yield and profitability by reducing waste caused by spoilage.

Some crops are delicate and require careful handling to avoid bruising. For example, harvesters often use ladders to access and collect the yield. The timing of harvests often depends on environmental factors, such as weather conditions and ripening cycles, which require close monitoring and flexibility in operations.

### SUMMARY

Apparatus and associated methods relate to a robot with a multi-axis end effector configured to operate produce into a collection guideway that is separate from the end effector. In an illustrative example, an end effector may include a rotating device configured to rotate the end effector about a longitudinal axis. The rotating device may, for example, be actuated by a linear actuator. The linear actuator may, for example, be operably coupled to a vacuum pump. The vacuum pump may, for example, produce a negative pressure within the end effector. The negative pressure within the end effector may, for example, join a produce to the end effector. The end effector may, for example, deposit the produce in the guideway. The guideway may, for example, be coupled to a container. Various embodiments may, for example, advantageously enable the robot to harvest produce to a container with few movements.

Various embodiments may achieve one or more advantages. Some embodiments may, for example, advantageously enable delicate handling of crops. Some embodiments may, for example, advantageously enable accurate identification of crops. Some embodiments may, for example, advantageously enable adaptability to various crop sizes and layout. Some embodiments may, for example, advantageously enable increased efficiency. Some embodiments may, for example, advantageously enable the reduction of manual labor.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary robotic crop harvesting vehicle system employed in an illustrative use-case scenario.

FIG. 2A depicts an exemplary schematic of an end effector.

FIG. 2B depicts an exemplary schematic of a rack-pinion.

FIG. 3A depicts an exemplary schematic of a robotic crop harvesting arm.

FIG. 3B depicts an exemplary schematic of a guideway.

FIG. 3C depicts an exemplary schematic of a second embodiment of a robotic crop harvesting arm.

FIG. 3D depicts an exemplary schematic of a second embodiment of a guideway.

FIG. 3E depicts an exemplary schematic of a third embodiment of a guideway.

FIG. 3F depicts an exemplary scissor lift device

FIG. 4 depicts a flowchart illustrating the operation of a robotic crop harvesting arm and an end effector.

FIG. 5A depicts an exemplary schematic of a container.

FIG. 5B depicts an exemplary scenario of surface leveling within a container.

FIG. 5C depicts an exemplary schematic of a lid of a container.

FIG. 5D is a flowchart illustrating surface leveling within a container.

FIG. 6A depicts an exemplary schematic of an autonomous vehicle.

FIG. 6B is a flowchart illustrating an autonomous vehicle navigation method.

FIG. 7 is a block diagram depicting an illustrative architecture of an example computer module within the robotic crop harvesting vehicle system.

FIG. 8 depicts an illustrative method of training models.

FIGS. 9A-9C depict an exemplary embodiment of a container.

FIG. 10 depicts an exemplary block diagram of an example computer module within the robotic crop harvesting vehicle system including a fleet management engine.

FIG. 11 depicts a method of operations performed by a computer module to illustrate an end-effector-centric training deployment workflow.

Like reference symbols in the various drawings indicate like elements.

### DETAILED DESCRIPTION OF ILLUSTRATIVE EMBODIMENTS

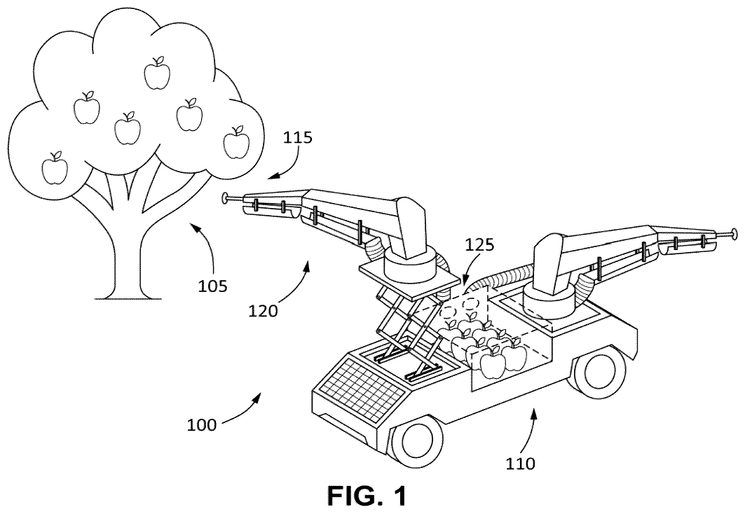

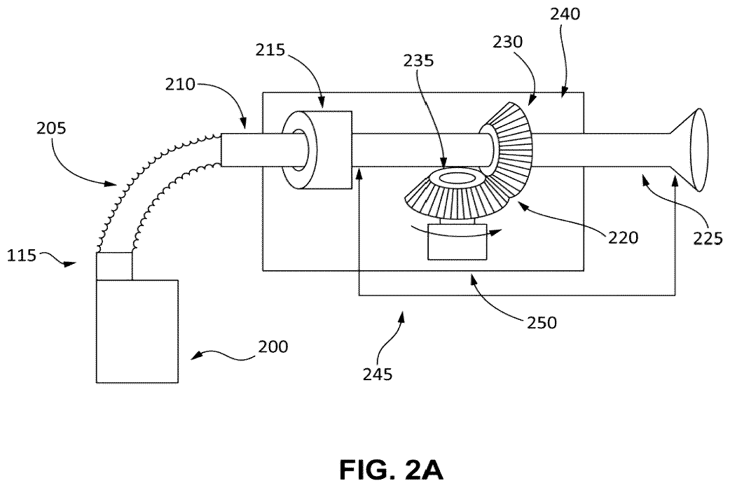

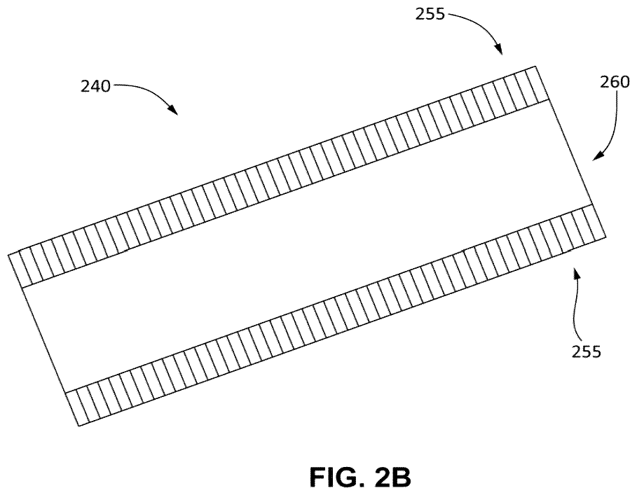

To aid understanding, this document is organized as follows. First, to help introduce discussion of various embodiments, a robotic crop harvesting vehicle system is introduced with reference to FIG. 1. Second, that introduction leads into a description of the various potential features of the robotic crop harvesting vehicle system with reference to FIGS. 2A-10 of some exemplary embodiments of an end effector, a robotic crop harvesting arm, a guideway, a container, and an autonomous vehicle. Finally, the document discusses further embodiments, exemplary applications and aspects relating to robotic crop harvesting vehicle system.

FIG. 1 depicts an exemplary robotic crop harvesting vehicle system 100 employed in an illustrative use-case scenario. In this scenario, the example includes a crop 105 to be harvested. For example, the crop 105 may include apples, as depicted. In this scenario, the crop 105 may, for example, be harvested by a robotic crop harvesting arm 120. The robotic crop harvesting arm 120 may, for example, engage the crop 105 by an end effector 115.

FIG. 2A depicts an exemplary schematic of the end effector 115. The end effector 115 may, for example, include a vacuum pump 200. The vacuum pump 200 may, for example, utilize suction to induce the crop 105 to engage the end effector 115. The end effector 115 may, for example, include a rotating device configured to rotate the end effector 115 about a longitudinal axis. The rotating device may, for example, be actuated by a linear actuator 245. The linear actuator 245 may, for example, actuate the rotating device of the end effector 115 to facilitate the removal of the crop 105 from its plant. In operation, the end effector 115 is configured to attach to the crop 105, rotate the crop 105 about a longitudinal axis, and retract away from the plant to remove the crop 105. Once the crop 105 is removed from the plant and coupled to the end effector 115, the end effector 115 may, for example, deposit the crop 105 into a guideway 300. The guideway 300 may, for example, enable the crop 105 to enter a container 125 via gravity. The robotic crop harvesting vehicle system 100 may, for example, advantageously enable the robotic crop harvesting arm 120 to harvest crops into a container 125 with few movements back and forth.

In an exemplary embodiment of the robotic crop harvesting vehicle system 100, the robotic crop harvesting arm 120 may, for example, be coupled to an autonomous vehicle 110. The autonomous vehicle 110 may, for example, advantageously enable the robotic crop harvesting system 100 to position itself near the crops 105 without manual intervention. The autonomous vehicle 110 may, for example, advantageously enable the robotic crop harvesting system 100 to return to a crop collection facility without manual intervention once the container 125 of the robotic crop harvesting system 100 is full. The autonomous vehicle 110 may, for example, advantageously enable the robotic crop harvesting system 100 to avoid obstacles while collecting crops.

The end effector 115 includes a vacuum pump 200. The vacuum pump 200 may, for example, be operably coupled to the end effector 115. For example, the vacuum pump 200 may be fluidly coupled to the end effector 115 such that a negative pressure may be applied to crops 105 by the end effector 115. The negative pressure applied to a crop 105 may, for example, join the crop 105 to the end effector 115. The utilization of the vacuum pump 200 to harvest the crop 105 may, for example, advantageously enable delicate handling of the crop 105.

The end effector 115 includes a flexible tube 205. The flexible tube 205 may, for example, operably couple the vacuum pump 200 to the end effector 115. The flexible tube 205 may, for example, expand or contract. For example, the flexible tube 205 may advantageously facilitate the movement of the end effector 115 by its ability to expand and contract.

The flexible tube 205 may, for example, be operably coupled to the nonrotating pipe 210. The nonrotating pipe 210 may, for example, be operably coupled via a bearing housing 215, to a rotating pipe 225 on the opposite end from the nonrotating pipe 210 that is coupled to the flexible tube 205. A net may be provided at an opening of the rotating pipe 210 to prevent debris from being drawn into the rotating pipe 210. The rotating pipe 225 may, for example, be rotated by the bevel gear system 220. The bevel gear system 220 includes a first bevel gear 230 and a second bevel gear 235. The first bevel gear 230 may, for example, be operably coupled to the rotating pipe 225. The second bevel gear 235 may, for example, be operably coupled with the first bevel gear 230 at a 90-degree angle. The second bevel gear 235 may, for example, include a motor 250. The motor 250 of the second bevel gear 235 may, for example, actuate the bevel gear system 220. Once the bevel gear system 220 is actuated, the second bevel gear 235 may, for example, rotate. The rotation of the second bevel gear 235 may, for example, rotate the first bevel gear 230. The rotation of the first bevel gear 230 may, for example, rotate the rotating pipe 225. The rotation of the rotating pipe may, for example, advantageously enable the end effector 115 to dislodge crops 105 from their plants.

FIG. 2B depicts an exemplary schematic of a rack-pinion 240. The end effector 115 includes a rack-pinion 240. The rack-pinion 240 includes two racks 255 on each side which mesh with two pinion gears in the middle portion 260. The rotating pipe may, for example, be fixed on the rack-pinion 240. The bevel gear system 220 may, for example, be fixed on the rack-pinion 240. The bearing housing 215, may for example, be fixed on the rack-pinion 240. The rack-pinion 240 may, for example, move forward and backward linearly. The rack-pinion 240 may, for example, advantageously enable the end effector to pull back and deposit fruit in the guideway 300.

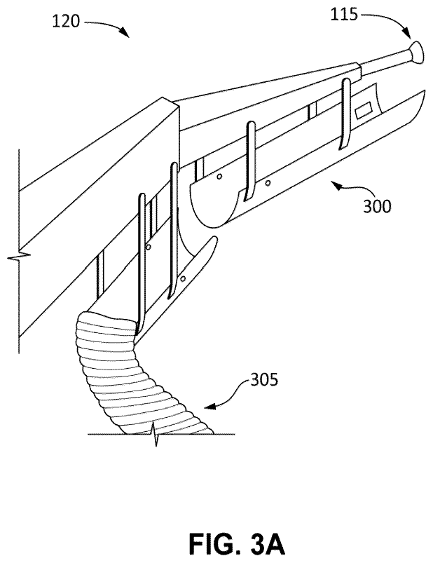

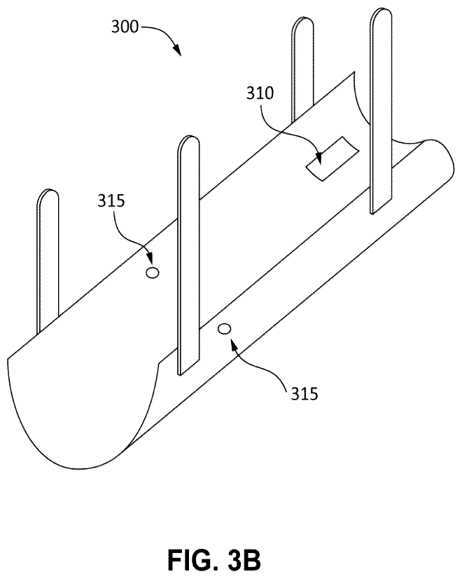

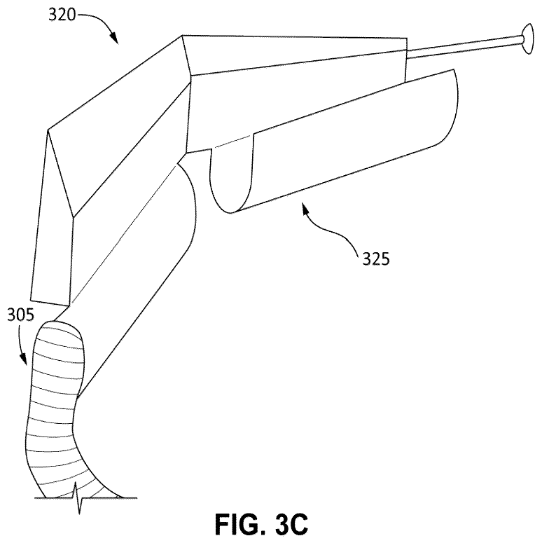

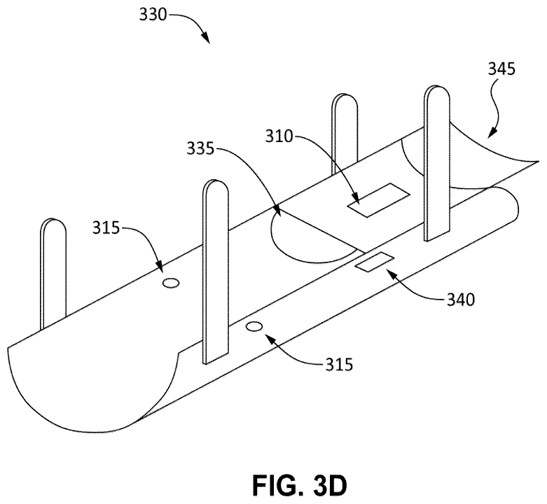

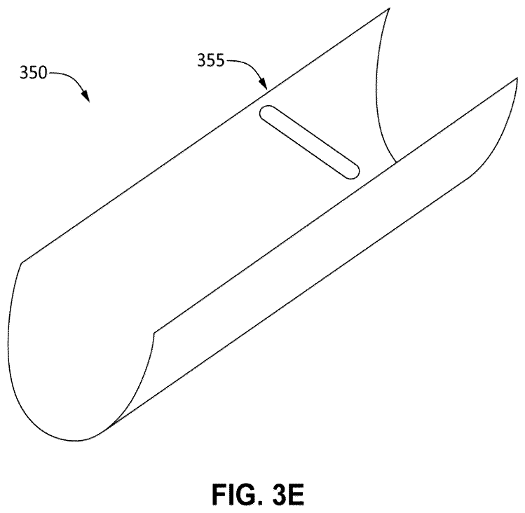

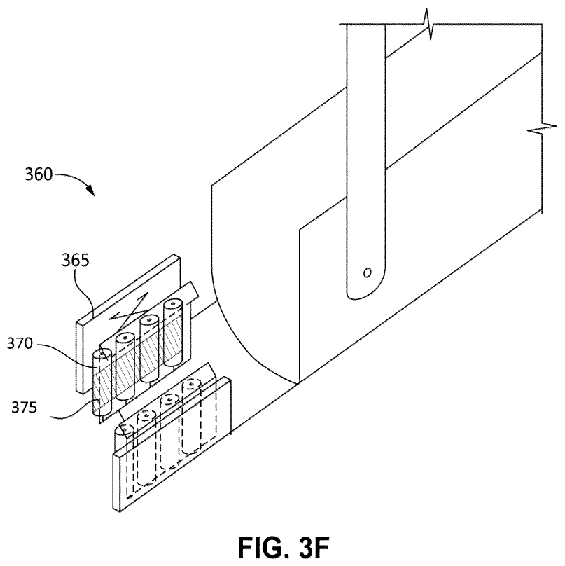

FIG. 3A depicts an exemplary schematic of a robotic crop harvesting arm 120. The robotic crop harvesting arm 120 includes an end effector 115. The end effector 115 may, for example, be configured to deposit crops into a guideway 300 that is separate from the end effector 115. For example, the guideway 300 may be suspended beneath the end effector 115. The guideway 300 may, for example, be operably coupled to an adjustable flexible tube 305. The guideway may, for example, deposit crops to the adjustable flexible tube 305 via gravity. The adjustable flexible tube 305 may, for example, deposit crops into a container 125 via gravity.

A camera may, for example, be coupled to a top of the robotic arm. The camera may, for example, detect the type of crop to be harvested. The camera may, for example, calculate the distance from the end effector 115 to the crops. The camera may, for example, utilize OpenCV (available from https://github.com/opencv/opencv) as the computer vision processing software that detects the type of crop being harvested or distance from end effector 115. The camera may, for example, utilize Yolov9 (available from https://github.com/WongKinYiu/yolov9) as the computer vision processing software that detects the type of crop being harvested or distance from end effector 115.

The robotic crop harvesting arm 120 operatively couples, for example, a height adjustable stool 600 to which it may be mounted. The height adjustable stool 600 may, for example, include a scissor lift 605 to lift the stool up or down. The height adjustable stool 600 may, for example, include an actuator to lift the stool up or down. The actuator may, for example, include a telescopic linear actuator. The actuator may, for example, include a motor. The actuator may, for example, include a pneumatic device. The actuator may, for example, include a hydraulic device. A height adjustable cover may, for example, be installed to protect the height adjustable stool. The height adjustable stool may, for example, advantageously enable the collection of crops at different heights.

FIG. 3B depicts an exemplary schematic of a guideway 300. The guideway 300 may, for example, include soft cushion as its internal walling. The soft cushion may, for example, advantageously protect fruit from damage upon entry into the guideway. The guideway 300 may for example, include seismic sensors 310. For example, the seismic sensors 310 may include inertial measurement units (IMUs). For example, the seismic sensors 310 may include accelerometers. For example, the seismic sensors 310 may include gyroscopes. The seismic sensors 310 may, for example, advantageously detect successful reception of the crop in the guideway 300.

The guideway 300 may, for example, include infrared (IR) sensors 315. The IR sensors 315 may advantageously detect successful reception of the crop in the guideway 300. The guideway 300 may, for example, include a deep reinforcement learning (DRL) strategy to monitor and learn from any errors made by the seismic and IR sensors. The DRL agent may, for example, receive signals from some but not all IR and seismic sensors, in which case, the DRL agent may, for example, advantageously learn what went wrong and find a way to reduce errors.

FIG. 3C depicts an exemplary schematic of a second embodiment of a robotic crop harvesting arm 320. The second embodiment of the robotic crop harvesting arm 320 includes a guideway 325 positioned inside the robotic crop harvesting arm 320. This second embodiment of the robotic crop harvesting arm 320 may advantageously protect crops from precipitation.

FIG. 3D depicts an exemplary schematic of a second embodiment of a guideway 330. The second embodiment of the guideway 330 includes a thin part 345. The second embodiment of the guideway 330 includes a semi-circle door 335. The second embodiment of the guideway 330 includes a motor 340. The thin part 345 may, for example, collect rotten crops. The semi-circle door 335 may, for example, open itself via the actuation of the motor 340. The opening of the semi-circle door may for example, enable the rotten crop to drop out of the guideway 330. The second embodiment of the guideway 330 may, for example, advantageously prevent the collection of rotten crops.

FIG. 3E depicts an exemplary schematic of a third embodiment of a guideway 350. The third embodiment of the guideway 350 includes a horizontal slot hole 355. The horizontal slot hole 355 may, for example, advantageously help remove precipitation that enters the guideway 350.

FIG. 3F depicts an exemplary scissor lift device 360. The exemplary scissor lift device 360 includes a scissor lift 365. The scissor lift device may, for example, be used to move (e.g., push) the belt drive forward. The scissor life device may, for example, be used to move the belt drive backward. The scissor lift may, for example, be used to create an appropriate grip of the fruit. For example, the guideway 330 may, include the scissor lift device 360.

The exemplary scissor lift may, for example, include opposing rotating drums 370 to move the fruit in an inward direction (rotating clockwise and counterclockwise to move the fruit inward). The belt may, for example, include a rough surface 375 The rough surface may, for example, be used to create a firm grip on the fruit. The rough surface 375 may, for example, include a belt.

In some embodiments, the suction pipe may, for example, include a pressure sensor to ensure that the fruit is securely attached throughout the harvesting process. The pressure sensor may, for example, monitor suction levels when the fruit is first attached, during its rotation, and as it is pulled back. If the sensor consistently shows a stable value across these phases, it may, for example, indicate that the fruit remains attached to the suction pipe and is ready for deposition into the guideway.

In some embodiments, the guideway may, for example, include an improved gripper device with rolling cylinders on both sides. These cylinders may, for example, press together to grip the fruit securely and then rotate to pull it back into the collection system. This device may, for example, replace the current curved plate design, which may push fallen or rotten fruits rather than effectively collecting them. The gripper device may, for example, also handle good fruits if applicable, enhancing the system's versatility.

In some embodiments, the vehicles may, for example, incorporate satellite communication modules for geolocation and operational monitoring in remote areas lacking internet or cellular connectivity. These modules may, for example, transmit data to a satellite constellation, which may then relay the information to ground stations connected to an AWS cloud server. A UI application deployed on the AWS server may, for example, allow users to access vehicle data and status through web browsers on PCs or mobile devices.

In some embodiments, a master-servant vehicle architecture may, for example, be implemented to reduce satellite communication costs. For every 15 vehicles, two may, for example, function as master vehicles, while the remaining 13 may, for example, serve as servants. Servant vehicles may, for example, poll their master every five seconds, and if a response is not received within a predetermined time, the system may, for example, flag a potential failure. The master vehicles may, for example, broadcast operational data such as battery levels, GPS coordinates, and sensor feedback to the UI application, ensuring comprehensive monitoring.

In some embodiments, the guideway sensors may, for example, leverage a deep reinforcement learning (DRL) strategy to enhance error detection and handling. The DRL agent may, for example, analyze data from seismic and infrared (IR) sensors to detect successful fruit reception and learn from operational errors. This adaptive system may, for example, continuously improve sensor accuracy and harvesting efficiency by minimizing damage to crops during collection.

In some embodiments, vehicles may, for example, include identification numbers displayed on weather-resistant stickers for efficient tracking. The master vehicles may, for example, broadcast these IDs along with operational data such as status updates and location coordinates. A UI application may, for example, integrate Google Maps to visually represent the operational and failure status of vehicles, aiding in real-time fleet management.

In some embodiments, autonomous vehicles may, for example, utilize dual energy sources, such as solar panels and plug-in battery systems, to ensure uninterrupted operation. The solar panels may, for example, charge onboard batteries during the day, while the plug-in systems may, for example, serve as backups, offering a sustainable and reliable energy solution.

In some embodiments, the container system may, for example, be enhanced with advanced actuators and IR sensors to optimize fruit deposition and leveling. The container's leveling surface may, for example, lower itself as more fruit is added, reducing the impact of the drop. IR sensors may, for example, detect when the container is full and signal the harvesting system to stop collection, preventing overflow and fruit damage.

In some embodiments, the guideway 300 may, for example, be U-shaped. The guideway 300 may, for example, be rectangular. The guideway 300 may, for example, be V-shaped.

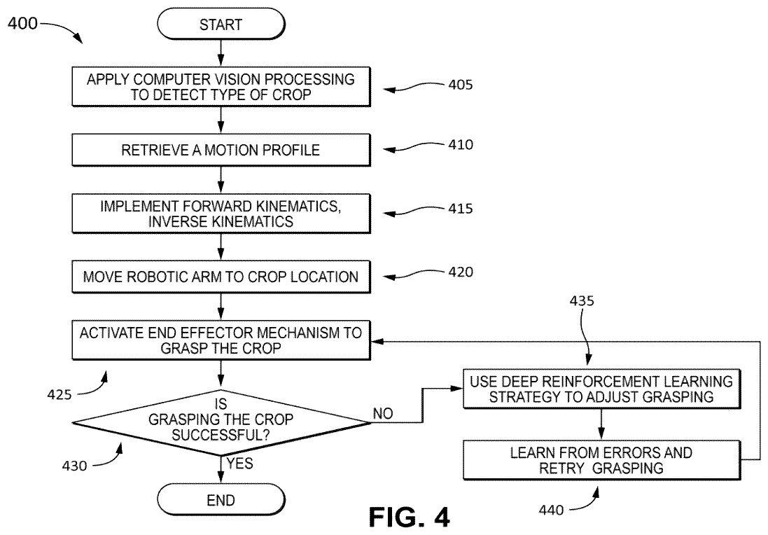

FIG. 4 is a flowchart illustrating the operation of a robotic crop harvesting arm and an end effector 400. The robotic crop harvesting arm 120 may, for example, include an end effector 115. The end effector 115 may, for example, be operably coupled to a camera. In step 405, the camera coupled to the end effector 115 may for example, detect the crop 105 to be harvested. The camera may, for example, include computer vision processing software to detect the crop 105 to be harvested. The camera may, for example, include OpenCV (available from https://github.com/opencv/opencv) as the computer vision processing software that detects the crop 105 being harvested. The camera may, for example, include Yolov9 (available from https://github.com/WongKinYiu/yolov9) as the computer vision processing software that detects the crop 105 being harvested.

In step 410, the image processing software may, for example, retrieve a motion profile. In step 415, the image processing software may, for example, undergo the process of forward kinematics and inverse kinematics to position and orient the end effector 115 in space. In step 420, the robotic crop harvesting arm 120 may, for example, move to the location of the crop 105. In step 425, the end effector 115 may, for example, activate and utilize suction to grasp the crop 105. In step 430, the robotic crop harvesting arm 120 either successfully grasps the crop 105 or drops the crop 105. If the robotic crop harvesting arm 120 drops the crop 105, then in step 435, the DRL agent may, for example, adjust the grasping device of the end effector 115. If the robotic crop harvesting arm 120 drops the crop, then in step 440, the DRL agent may, for example, learn from the error.

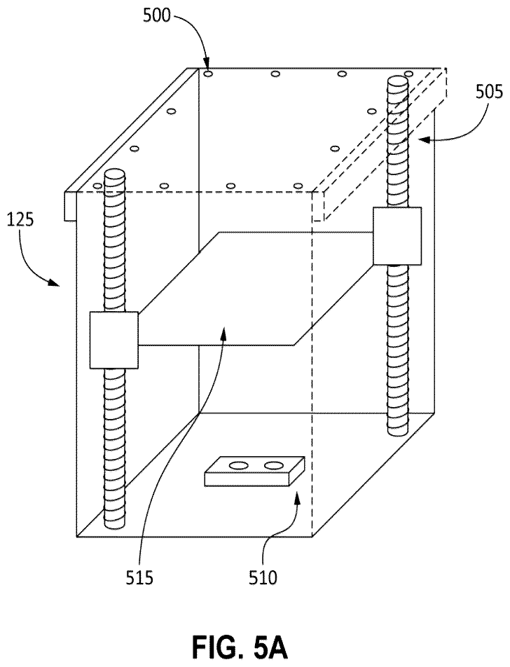

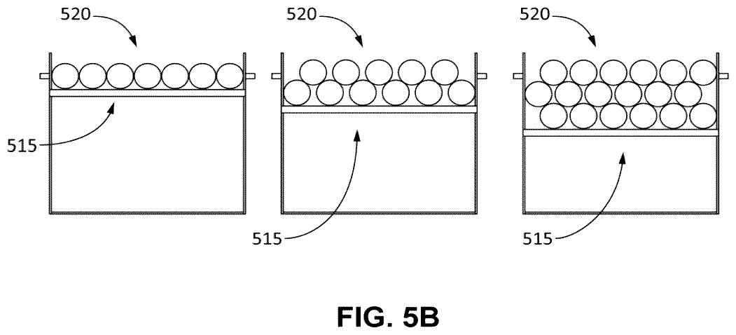

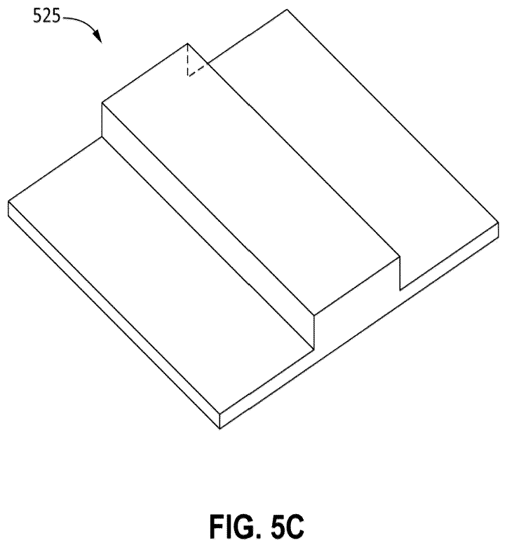

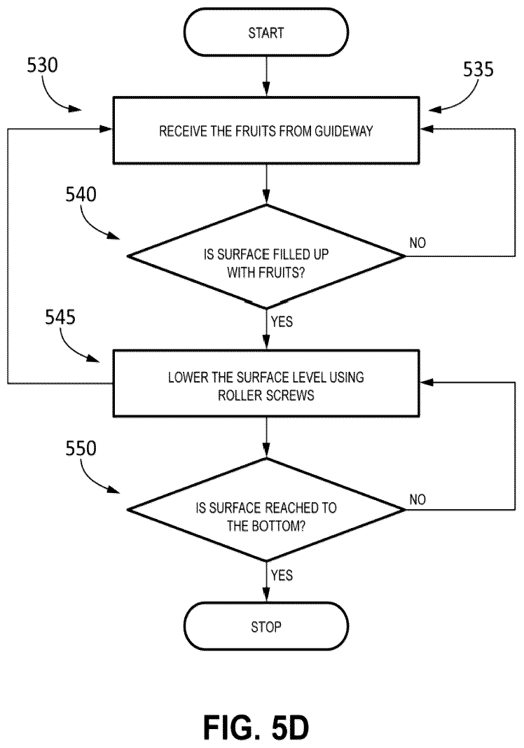

FIG. 5A depicts an exemplary schematic of a container 125. FIG. 5B depicts an exemplary scenario of surface leveling within a container 125. The container 125 includes a level adjusting surface 515. The level adjusting surface 515 may, for example, lower its level as more weight is added. The level adjusting surface may, for example, advantageously prevent crops from entering at a high velocity by reducing the drop impact. The container 125 includes a screw-based actuator 505. The screw-based actuator 505 may, for example, be roller screws. The screw-based actuator 505 may, for example, be operably coupled to the level adjusting surface 515. The screw-based actuator 505 may, for example, operate by a bevel gear system with motors. The screw-based actuator 505 may, for example, advantageously enable the level adjusting surface 515 to move. For example, the level adjusting surface may move up and down in a straight-line direction.

The container 125 includes IR transmitters and receivers 500. If the container 125 is filled with crops, then IR signals emitted from the IR transmitters 500 may, for example, be blocked. The blocked IR signal may, for example, result in the IR receivers 500 not receiving the IR signal. If the container 125 is not full, then, IR signals emitted from the IR transmitters 500 may, for example, be received by the IR transmitters 500. The IR transmitters 500 that received the IR signal may, for example, signal to the robotic crop harvesting arm 120 to continue harvesting crops.

The container 125 includes an IR proximity distance sensor 510 located at the container's bottom. The IR proximity distance sensor 510 may, for example, sense the level adjusting surface 515 when the level adjusting surface 515 reaches the bottom of the container 125. When the IR proximity distance sensor 510 senses the level adjusting surface 515, then the IR proximity distance sensor 510 may, for example, send a signal to the robotic crop harvesting vehicle system 100 via a microcontroller to stop crop collection.

FIG. 5C depicts an exemplary schematic of a container lid 525. The container lid 525 may, for example, be placed on the container 125 manually. The container lid 525 may, for example, advantageously protect the collected crops 105 from snow or rain.

FIG. 5D is a flowchart 530 illustrating surface leveling within a container. In step 535, the level adjusting surface 515 may, for example, receive the crop 105 from the guideway 300. In step 540, IR transmitters and receivers 500 may, for example, determine if the container 125 is full. In step 545, as crops 105 are added to the level adjusting surface 515, the level adjusting surface 515 may, for example, lower itself within the container 125. For example, the screw-based actuator 505 may operate to lower the level adjusting surface 515. In step 550, the IR proximity distance sensor 510 may, for example, determine if the level adjusting surface 515 has reached the bottom of the container 125. If the IR proximity distance sensor 510 determines the level adjusting surface 515 has reached the bottom of the container 125, then the IR proximity distance sensor 510 may, for example, send a signal to the robotic crop harvesting vehicle system to stop the collection of crops.

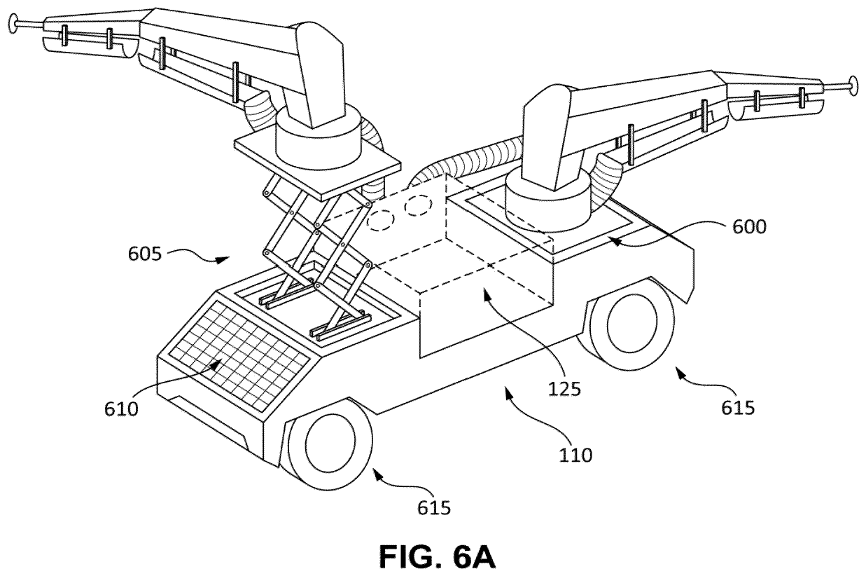

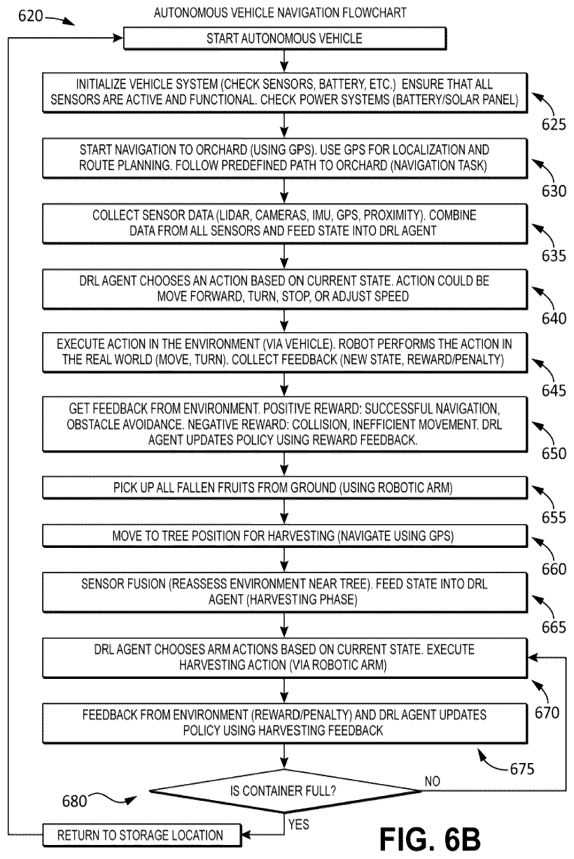

FIG. 6A depicts an exemplary schematic of an autonomous vehicle 110. The autonomous vehicle includes wheels 615. The autonomous vehicle 110 includes a space for a container 125. The autonomous vehicle 110 may, for example, be operably coupled to an at least one robotic crop harvesting arm 120. The autonomous vehicle may include, for example, an energy source. The energy source may, for example, include a plug. The energy source may, for example, include a solar panel 610 as depicted. The solar panel 610 may, for example, charge a power storage module. For example, the power storage module may include an external battery.

The autonomous vehicle 110 may, for example, be configured to fuse data together from various sensors. The autonomous vehicle 110 may include, for example, proximity sensors to detect close range objects. The proximity sensors may, for example, include ultrasonic sensors. The proximity sensors may, for example, include LIDAR. The autonomous vehicle 110 may include, for example, a global positioning system (GPS) for localization and global positioning in real time. The autonomous vehicle 110 may include, for example, real time kinematic positioning (RTK) GPS for localization and global positioning in real time. The autonomous vehicle 110 may include, for example, an IMU to track orientation and movement of the autonomous vehicle 110. The autonomous vehicle 110 may include, for example, the DRL agent. The DRL agent may, for example, be utilized for sensor fusion operations. The sensor fusion may, for example, advantageously enable the autonomous vehicle 110 to provide distance measurements between the vehicle and obstacles. The sensor fusion may, for example, advantageously enable the autonomous vehicle 110 to avoid obstacles. The sensor fusion may, for example, advantageously enable the autonomous vehicle 110 to navigate to a destination without manual intervention.

FIG. 6B is a flowchart illustrating an autonomous vehicle navigation method 620. In step 625, the autonomous vehicle system 100 is initialized. The autonomous vehicle system 100, may for example, ensure sensors and power systems are functional and operating. In step 630, the autonomous vehicle 110 may, for example, begin navigating toward a crop 105. The autonomous vehicle 110 may, for example, utilize GPS to follow a predefined path to the crops 105. In step 635, the autonomous vehicle 110 sensors may, for example, collect data and feed its state into the DRL agent. The autonomous vehicle 110 sensors may include, for example, light detection and ranging (LIDAR). The autonomous vehicle 110 sensors may include, for example, cameras. The autonomous vehicle 110 sensors may include, for example, the IMU. The autonomous vehicle 110 sensors may include, for example, GPS. The autonomous vehicle 110 sensors may include, for example, proximity sensors.

In step 640, the DRL agent may, for example, choose an action based on its current state. The DRL agent may, for example, choose to move forward. The DRL agent may, for example, choose to turn. The DRL agent may, for example, choose to stop. The DRL agent may, for example, choose to adjust speed. In step 645, the autonomous vehicle 110 may, for example, execute an action in the environment. In step 650, the autonomous vehicle 110 collects feedback from the environment. The feedback may, for example, be a positive reward. The positive reward may, for example, be a successful navigation. The positive reward may, for example, be an obstacle avoidance. The feedback may, for example be a negative reward. The negative reward may, for example, be a collision. The negative reward may, for example, be an inefficient movement. Based on the reward feedback, the DRL agent may, for example, update the policy of the autonomous vehicle 110.

In step 655, the autonomous vehicle 110 may, for example, be operably coupled to a robotic crop harvesting arm 120. The robotic crop harvesting arm 120 may, for example, pick up fallen crops 105. In step 660, the autonomous vehicle 110 may, for example, navigate via GPS to the crops 105 for harvesting. In step 665, the autonomous vehicle 110 may, for example, utilizes sensor fusion to reassess environment and feed the autonomous vehicle's 110 state into DRL agent. In step 670, the DRL agent may, for example, choose an action for the coupled robotic crop harvesting arm 120 based on the state of the autonomous vehicle 110. The DRL agent may choose, for example, to execute a harvesting action via the robotic crop harvesting arm 120. In step 675, the DRL agent receives harvesting feedback from the environment via sensor fusion. Once the DRL agent receives harvesting feedback from the environment, the DRL agent may, for example, update the policy of autonomous vehicle 110. In step 680, the autonomous vehicle 110 may, for example, sense if the container 125 is full via the IR proximity distance sensor 510 within the container 125. If the autonomous vehicle 110 senses the container 125 is full, then the autonomous vehicle 110 may, for example, return to a crop storage location utilizing GPS to navigate itself. At storage locations workers may empty container 125 so that autonomous vehicle 110 can start to navigate to the orchard location to harvest.

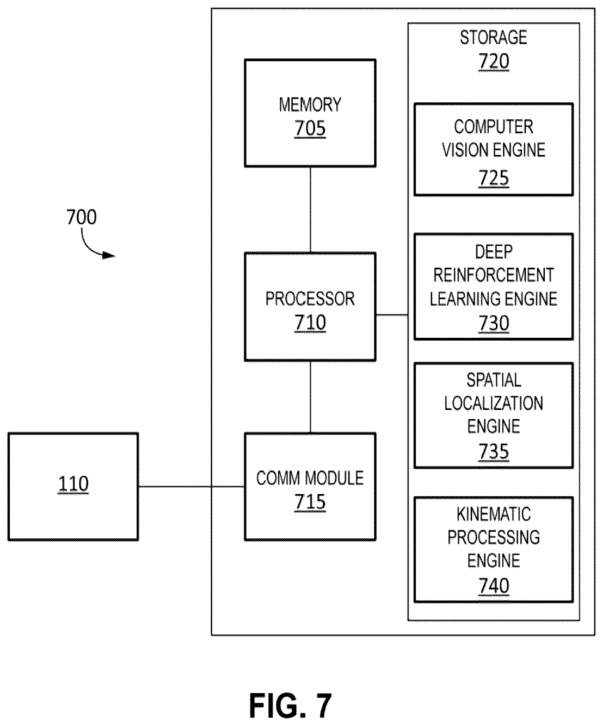

FIG. 7 is a block diagram depicting an illustrative architecture of an example computer module 700 within the robotic crop harvesting vehicle system. In this example, the robotic crop harvesting vehicle system includes a processor 710 operably coupled to memory module(s) 705. The processor 710 is operably coupled to a communication module(s) 715. The processor 710 is operably coupled to one or more storage module(s) 720.

The DRL engine 730 may be implemented as processor executable instructions on the one or more storage module 720. For example, the DRL engine 730 may be one or more storage module 720 with and/or operably coupled to the computer vision engine 725, spatial localization engine 735, and/or kinematics processing engine 740.

The DRL engine 730 may, for example, collect inputs from multiple sources. Inputs may, for example, include environmental and contextual data. Environmental and contextual data may, for example, come from a camera. An input may include, for example, qualitative sensor data. Qualitative sensor data may, for example, come from a spatial sensor. The spatial sensor may, for example, include a GPS. Sensor data may, for example, come from a distance measurement sensor. The distance measurement sensor may, for example, include a LIDAR. Sensor data may, for example, include a seismic sensor 310. A seismic sensor may, for example, include an IMU. Sensor data may, for example, come from a proximity sensor. A proximity sensor may, for example include an IR sensor.

The DRL engine 730 may, for example, analyze the collected data from the inputs and generate action(s). The DRL engine 730 may, for example, identify errors made by the computer vision engine 725, spatial localization engine 735, and/or kinematics processing engine 740. The DRL engine 730 may, for example, correct the identified errors made by the computer vision engine 725, spatial localization engine 735, and/or kinematics processing engine 740. The DRL engine 730 may, for example, advantageously enable the robotic crop harvesting system 100 to increase the system's reliability. The DRL engine 730 may, for example, advantageously enable the robotic crop harvesting system 100 to improve the system's efficiency. The DRL engine 730 may, for example, advantageously enable the robotic crop harvesting system 100 to continuously improve the system.

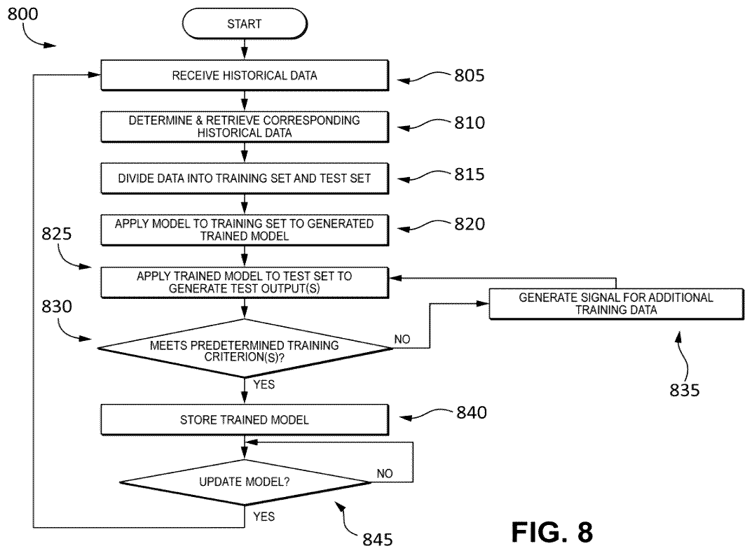

FIG. 8 depicts an illustrative method of a training model(s). A method 800 may, for example be performed by a processor(s) (e.g., processor 710) executing a program(s) of instructions retrieved from a data store(s). The method includes, in step 805, receiving historical data. The data may, for example, include environmental and contextual data. The data may, for example, include qualitative sensor data. In step 810, corresponding historical data from the same and/or other sources are determined and retrieved. In step 815, the retrieved data is divided into a first set of data used for training and a second set of data used for testing. In step 820, a model is applied to the training data to generate a trained model. For example, the model may include the DRL engine 730. In step 825, the trained model is applied to the testing data to generate test output(s). In step 830, the output is evaluated in a decision point to determine whether the model is successfully trained (e.g., by comparison to a predetermined training criterion(s)). In step 835, the processor may generate a signal(s) requesting additional training data, and the method 800 loops back to step 825. In step 840, if the model is determined to be successfully trained, then the trained model may be stored, and the method may, for example, end. Some embodiments may, for example, include dynamic training and/or updating of the model(s). For example, the method of 800, may include a decision point 845 where a model update trigger is monitored. When the trigger is detected, then the method 800 may return to step 805.

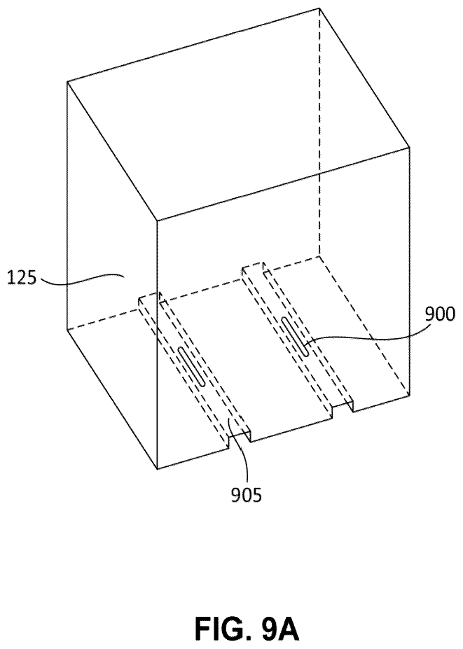

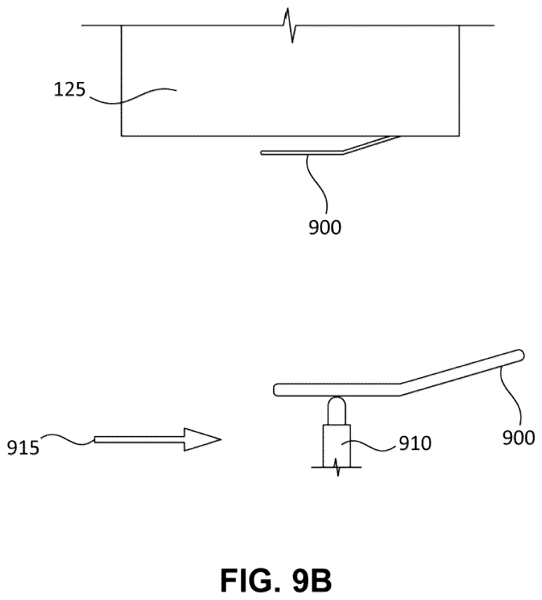

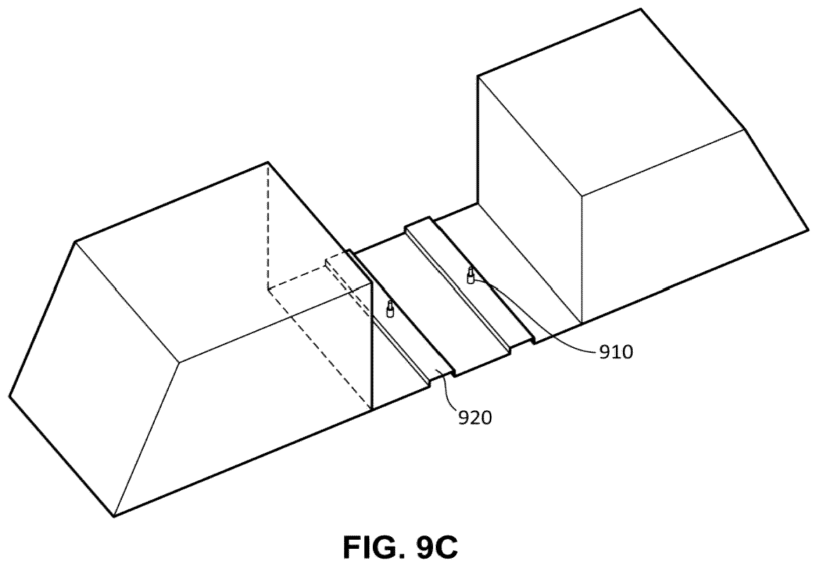

FIGS. 9A-9C depict an exemplary embodiment of a container 125. The container 125 may, for example, include a metal plate 900. The metal plate 900 may, for example, be formed of copper. The metal plate 900 may, for example, be configured to receive electrical contact from a pogo pin 910. The metal plate 900 may, for example, conduct electrical current to a digital circuit within the container 125. The metal plate 900 may, for example, advantageously provide a durable and low-resistance interface surface. The metal plate 900 may, for example, be positioned within a slot 905 to align with incoming electrical terminals.

The container 125 may, for example, include one or more slots 905. The slots 905 may, for example, be shaped to receive one or more protrusions 920 disposed on a vehicle. The slots 905 may, for example, slide over the protrusions 920 when the container 125 is mounted. The slots 905 may, for example, guide the movement of the container 125 along a defined container slide direction 915. The slots 905 may, for example, advantageously ensure stable mechanical engagement with the protrusions 920. The slots 905 may, for example, position the pogo pin 910 in electrical contact with the metal plate 900.

The container 125 may, for example, include a pogo pin 910. The pogo pin 910 may, for example, be spring-loaded. The pogo pin 910 may, for example, compress when the container 125 is slid into position. The pogo pin 910 may, for example, supply positive electrical potential. The pogo pin 910 may, for example, supply negative electrical potential. The pogo pin 910 may, for example, be configured to press against the metal plate 900 during operation. The pogo pin 910 may, for example, advantageously create a self-adjusting electrical interface that maintains constant contact despite vibration. The pogo pin 910 may, for example, align with the metal plate 900 when the one or more slots 905 guide the container 125 into position.

The container 125 may, for example, include one or more protrusions 920. The protrusions 920 may, for example, be disposed on the vehicle rather than on the container. The protrusions 920 may, for example, carry electrical terminals that mate with the pogo pin 910. The protrusions 920 may, for example, be configured to slide into the slots 905. The protrusions 920 may, for example, advantageously ensure that the container 125 mounts securely to the vehicle. The protrusions 920 may, for example, receive the container 125 along the container slide direction 915.

In a use-case scenario, the container 125 may, for example, be positioned near the vehicle such that the slots 905 align with the protrusions 920. A user may, for example, push the container 125 along the container slide direction 915. As the container 125 moves forward, the slots 905 receive the protrusions 920 and mechanically stabilize the container 125 against the vehicle. During this sliding motion, the pogo pin 910 compresses and establishes electrical contact with the metal plate 900. The metal plate 900 conducts electrical power to internal components of the container 125. Once fully seated, the container 125 remains mechanically locked in position via the protrusions 920 and electrically powered through the pogo pin 910. The container 125 may, for example, advantageously be mounted and energized without separate wiring, tools, or manual electrical connections.

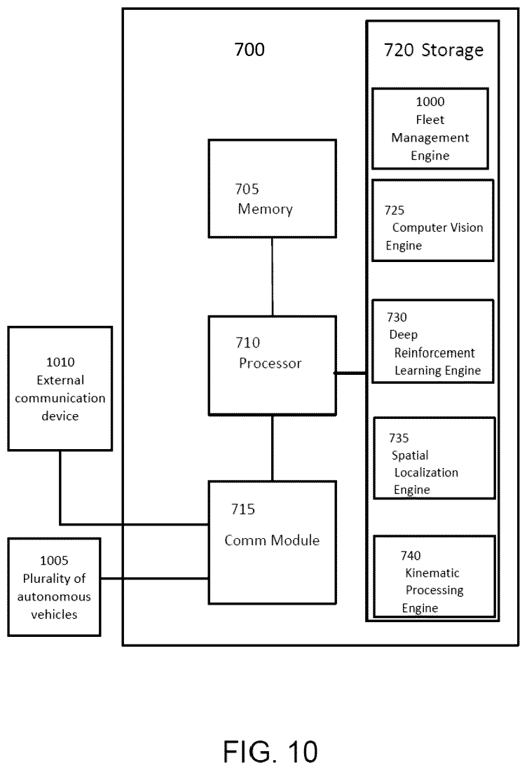

FIG. 10 depicts an exemplary block diagram of an example computer module 700 within the robotic crop harvesting vehicle system 100 including a fleet management engine 1000. The robotic crop harvesting vehicle system 100 may, for example, include a processor 710. The processor 710 may, for example, operatively couple to a memory module 705. For example, the memory module 705 may be configured to store instructions for execution. For example, the memory module 705 may provide temporary data storage for operations performed by the processor 710. The processor 710 may, for example, retrieve instructions from the memory module 705 to coordinate actions of the robotic crop harvesting vehicle system 100.

The processor 710 may, for example, operatively couple to a communication module 715. The processor 710 may, for example, transmit operational data to the communication module 715. The processor 710 may, for example, receive incoming data from the communication module 715. The communication module 715 may, for example, be configured to exchange signals with remote systems. For example, the communication module 715 may transmit telemetry from the robotic crop harvesting vehicle system 100. For example, the communication module 715 may receive navigation instructions from an external device. The processor 710 may, for example, use data from the communication module 715 to adjust vehicle behavior.

The processor 710 may, for example, operatively couple to a storage module 720. The processor 710 may, for example, retrieve long-term operational data from the storage module 720. The processor 710 may, for example, store harvested data logs within the storage module 720. The storage module 720 may, for example, be configured to retain system architectures used during operation. For example, the storage module 720 may maintain dedicated engines for perception, control, and decision-making.

The storage module 720 may, for example, include a fleet management engine 1000. The processor 710 may, for example, transmit vehicle status information to the fleet management engine 1000. The fleet management engine 1000 may, for example, be configured to perform multi-vehicle coordination. For example, the fleet management engine 1000 may monitor battery status across a plurality of vehicles. For example, the fleet management engine 1000 may organize task assignments for multiple robotic crop harvesting vehicles. The processor 710 may, for example, retrieve fleet-level decisions from the fleet management engine 1000. The fleet management engine 1000 may, for example, forward communication directives to the communication module 715.

The communication module 715 may, for example, be operatively coupled to a plurality of robotic crop harvesting vehicles 1005. The communication module 715 may, for example, deliver navigation updates from the processor 710 to the plurality of robotic crop harvesting vehicles 1005. The plurality of robotic crop harvesting vehicles 1005 may, for example, be configured to receive remote instructions for coordinated harvesting. For example, the plurality of robotic crop harvesting vehicles 1005 may adjust their motion profiles based on data received through the communication module 715. The processor 710 may, for example, receive performance feedback from the plurality of robotic crop harvesting vehicles 1005 through the communication module 715.

The communication module 715 may, for example, be operatively coupled to an external communication device 1010. The processor 710 may, for example, transmit outbound high-level status messages to the external communication device 1010. The external communication device 1010 may, for example, include satellite systems or remote network infrastructures. For example, the external communication device 1010 may transmit operational reports to a cloud-based monitoring platform. For example, the external communication device 1010 may receive over-the-air software updates from a remote server. The processor 710 may, for example, interpret incoming instructions received by the external communication device 1010 for use in navigation or fleet coordination.

The storage module 720 may, for example, include a computer vision engine 725. The processor 710 may, for example, provide image data to the computer vision engine 725. The computer vision engine 725 may, for example, be configured to detect fruit using image-processing algorithms. For example, the computer vision engine 725 may generate object-location estimates. For example, the computer vision engine 725 may classify fruit type based on visual characteristics. The processor 710 may, for example, use the output of the computer vision engine 725 to determine end-effector positioning commands.

The storage module 720 may, for example, include a deep reinforcement learning engine 730. The processor 710 may, for example, transmit environmental state information to the deep reinforcement learning engine 730. The deep reinforcement learning engine 730 may, for example, be configured to update policies that determine improved harvesting behaviors. For example, the deep reinforcement learning engine 730 may refine motion strategies based on reward feedback. For example, the deep reinforcement learning engine 730 may detect and correct errors in navigation or gripping. The processor 710 may, for example, retrieve action recommendations from the deep reinforcement learning engine 730 to control the robotic crop harvesting vehicle system 100.

The storage module 720 may, for example, include a spatial localization engine 735. The processor 710 may, for example, transmit sensor-fusion data to the spatial localization engine 735. The spatial localization engine 735 may, for example, be configured to estimate global and local positioning. For example, the spatial localization engine 735 may compute vehicle orientation using inertial data. For example, the spatial localization engine 735 may produce position values corrected by GPS or RTK data. The processor 710 may, for example, use output from the spatial localization engine 735 to plan navigation paths.

The storage module 720 may, for example, include a kinematic processing engine 740. The processor 710 may, for example, provide motion-profile requirements to the kinematic processing engine 740. The kinematic processing engine 740 may, for example, be configured to compute forward and inverse kinematics. For example, the kinematic processing engine 740 may determine proper joint angles for the robotic arm. For example, the kinematic processing engine 740 may calculate trajectories for efficient fruit harvesting. The processor 710 may, for example, execute these trajectories to actuate the robotic components of the system.

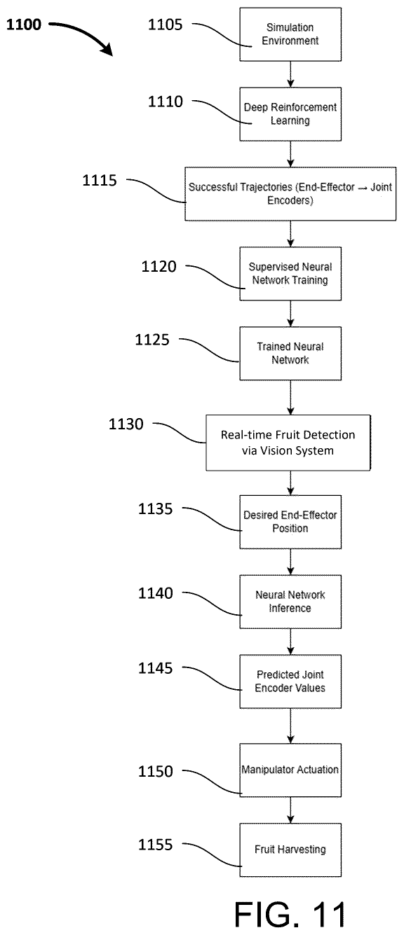

FIG. 11 depicts a method of operations 1100 performed by a computer module 700 to illustrate an end-effector-centric training deployment workflow. In a step 1105, during a training phase, a robotic manipulator (e.g., the robotic crop harvesting arm 120 and the end effector 115) is simulated in a virtual environment. For example, the computer module 700 may simulate the robotic manipulator by executing the DRL engine 730 over a virtualized robotic crop harvesting arm 120 and end effector 115 models, storing episode trajectories and configuration states to the memory module 705. In a step 1110, deep reinforcement learning is applied with rewards defined on successful end-effector task execution. For example, the DRL engine 730 may apply end-effector-success rewards by evaluating grasp success and collision avoidance at the end effector 115, recording reward logs and policy checkpoints in the memory module 705. For example, individual joints and intermediate links are not directly trained or optimized during the reinforcement learning process. In a step 1115, joint encoder values corresponding to successful end-effector positions and orientations are observed and recorded. For example, the kinematics processing engine 740 may record end-effector pose to joint-encoder pairs by reading the simulated encoder states and storing the pairs as a dataset in the memory module 705.

In a step 1120, a supervised neural network is subsequently trained using the recorded data to learn a mapping from desired end-effector poses to corresponding joint encoder values. For example, the processor 710 may train a supervised neural network by retrieving the pose-to-encoder dataset from the memory module 705 and updating model weights in memory module 705, persisting checkpoints to the storage module 720. In a step 1125, a trained neural network is generated based on the training of the supervised neural network. For example, the computer module 700 may generate and package the trained neural network by saving model artifacts and metadata to the storage module 720 and caching an inference instance in memory module 705.

In step 1130, during deployment of the trained neural network on the robotic crop harvesting vehicle system, a vision system detects crop locations. For example, the computer vision engine 725 may detect crop locations by processing camera frames and storing detection results in memory module 705 with periodic logs to the storage module 720. In step 1135, during deployment of the trained neural network on the robotic crop harvesting vehicle system, the vision system determines a desired end effector position. For example, the spatial localization engine 735 may determine a desired end-effector position by fusing vision detections with localization data and writing the resulting pose to memory module 705. In step 1140, the desired end effector position is provided as input to the trained supervised neural network. For example, the processor 710 may invoke the trained supervised neural network by retrieving the model from the storage module 720 and feeding the desired pose from memory module 705 into the network. In step 1145, the neural network outputs predicted joint encoder values. For example, the trained neural network may output predicted joint encoder values by computing encoder targets in memory module 705 and persisting inference outputs to the storage module 720. In step 1150, the joint encoder values are used to actuate a robotic manipulator. For example, the kinematics processing engine 740 may actuate the robotic manipulator by translating predicted encoder values into motor commands and streaming them through control loops in memory module 705 while logging execution to the storage module 720. In step 1155, real time fruit harvesting is enabled by the neural network outputs. For example, the guideway sensors 310 and 315 may validate crop reception by sending detection signals to memory module 705 for real-time control and writing event logs to the memory module 705.

Although various embodiments have been described with reference to the figures, other embodiments are possible.

In some embodiments the autonomous vehicle 110 may include a belt-drive mechanism for navigation. The belt-drive mechanism may, for example, include a continuous belt configured to transfer motion. The belt-drive mechanism may, for example, include a set of drive pulleys configured to support directional changes. The belt-drive mechanism may, for example, include tensioning structures configured to hold the belt in place. For example, the belt-drive mechanism may be configured to provide differential steering. For example, the belt-drive mechanism may include a motorized drive pulley configured to generate rotational force. The belt-drive mechanism may, for example, be configured to traverse uneven terrain. The belt-drive mechanism may, for example, be configured to maintain traction on soft agricultural soil. The belt-drive mechanism may, for example, advantageously reduce wheel slippage. The belt-drive mechanism may, for example, advantageously improve maneuverability in orchard environments.

In some embodiments the computer module 700 may include a PID controller. The PID controller may, for example, include proportional gain tuned to reduce position error. The PID controller may, for example, include integral gain tuned to eliminate steady-state error. The PID controller may, for example, include derivative gain tuned to prevent overshoot. For example, the PID controller may be configured to regulate motor output. For example, the PID controller may include an error-sensing circuit configured to detect deviations from a reference trajectory. The PID controller may, for example, be configured to stabilize the robotic arm. The PID controller may, for example, be configured to smooth autonomous vehicle motion. The PID controller may, for example, advantageously provide predictable control behavior. The PID controller may, for example, advantageously simplify software implementation.

In some embodiments the end effector 115 may include a gripper or claw assembly. The gripper or claw assembly may, for example, include opposing gripping members configured to secure a fruit. The gripper or claw assembly may, for example, include a hinge joint configured to open or close the gripping members. The gripper or claw assembly may, for example, include a soft interface surface configured to prevent fruit damage. For example, the gripper or claw assembly may be configured to detach fruit from a branch. For example, the gripper or claw assembly may include a motorized actuation system configured to contract the gripping members. The gripper or claw assembly may, for example, be configured to hold irregularly shaped produce. The gripper or claw assembly may, for example, be configured to maintain grip during arm retraction. The gripper or claw assembly may, for example, advantageously eliminate reliance on suction. The gripper or claw assembly may, for example, advantageously enable harvesting of produce unsuitable for vacuum methods.

In some embodiments the end effector 115 may include a suction pipe mechanism implemented as a linear actuator. The linear-actuator suction mechanism may, for example, include a telescoping housing configured to extend. The linear-actuator suction mechanism may, for example, include a piston configured to advance toward the fruit. The linear-actuator suction mechanism may, for example, include a seal configured to maintain suction pressure. For example, the linear-actuator suction mechanism may be configured to create a negative pressure region at its tip. For example, the linear-actuator suction mechanism may include a pressure chamber configured to generate suction force. The linear-actuator suction mechanism may, for example, be configured to retract the fruit toward the robotic arm. The linear-actuator suction mechanism may, for example, be configured to hold fruit during transport to the guideway. The linear-actuator suction mechanism may, for example, advantageously allow precise extension control. The linear-actuator suction mechanism may, for example, advantageously reduce reliance on flexible tubing.

In some embodiments the container 125 may include a lifting mechanism implemented as a linear actuator. The linear actuator may, for example, include a threaded rod configured to raise a platform. The linear actuator may, for example, include a motor housing configured to rotate the threaded rod. The linear actuator may, for example, include a support carriage configured to travel along the rod. For example, the linear actuator may be configured to adjust the height of a receiving surface. For example, the linear actuator may include a positional sensor configured to monitor platform height. The linear actuator may, for example, be configured to slow fruit descent. The linear actuator may, for example, be configured to maintain a gentle receiving surface. The linear actuator may, for example, advantageously reduce bruising.

In some implementations the container 125 may include a lifting mechanism implemented as a scissor mechanism. The scissor mechanism may, for example, include crossing arms configured to expand. The scissor mechanism may, for example, include a pivot joint configured to connect the crossing arms. The scissor mechanism may, for example, include a lift plate configured to support fruit. For example, the scissor mechanism may be configured to raise and lower the fruit collection platform. For example, the scissor mechanism may include a central actuator configured to apply lifting force. The scissor mechanism may, for example, be configured to maintain a stable platform. The scissor mechanism may, for example, advantageously distribute weight evenly. The scissor mechanism may, for example, advantageously allow compact retraction.

In some embodiments the guideway 300 may include a pipe. The pipe may, for example, include a rigid cylindrical structure configured to channel fruit. The pipe may, for example, include an internal surface configured to reduce friction. The pipe may, for example, include a mounting interface configured to couple to the robotic arm. For example, the pipe may be configured to direct fruit toward the container 125. For example, the pipe may include an angled terminus configured to control fruit output direction. The pipe may, for example, be configured to prevent produce from escaping sideways. The pipe may, for example, be configured to protect fruit from external debris. The pipe may, for example, advantageously simplify manufacturing. The pipe may, for example, advantageously reduce exposure to rain or wind.

In some implementations the guideway 300 may include a flexible pipe. The flexible pipe may, for example, include a bendable material configured to deform under load. The flexible pipe may, for example, include a ribbed structure configured to maintain airflow. The flexible pipe may, for example, include a coupling collar configured to attach to the end effector. For example, the flexible pipe may be configured to accommodate changes in arm orientation. For example, the flexible pipe may include a pliable segment configured to absorb impact. The flexible pipe may, for example, be configured to route fruit around obstacles. The flexible pipe may, for example, advantageously allow dynamic positioning. The flexible pipe may, for example, advantageously reduce stress on the arm assembly.

In some embodiments the container 125 may include a static container assembly. The static container assembly may, for example, include rigid sidewalls configured to receive fruit. The static container assembly may, for example, include a fixed base configured to support harvested produce. The static container assembly may, for example, include an open top configured to accept incoming fruit. For example, the static container assembly may be configured to store produce without dynamic height adjustment. For example, the static container assembly may include a reinforced bottom configured to withstand impact. The static container assembly may, for example, be configured to operate without electrical power. The static container assembly may, for example, be configured to remain detachable from the vehicle. The static container assembly may, for example, advantageously reduce mechanical complexity. The static container assembly may, for example, advantageously reduce cost.

In some embodiments the end effector 115 may include a rotation and pull-back mechanism compatible with suction or gripping systems. The rotation and pull-back mechanism may, for example, include a rotating shaft configured to turn the effector. The rotation and pull-back mechanism may, for example, include a coupling bracket configured to secure the effector. The rotation and pull-back mechanism may, for example, include a drive motor configured to rotate the shaft. For example, the rotation and pull-back mechanism may be configured to twist fruit free from its branch. For example, the rotation and pull-back mechanism may include a retraction assembly configured to pull fruit toward the arm. The rotation and pull-back mechanism may, for example, be configured to reduce gripping force. The rotation and pull-back mechanism may, for example, be configured to increase detachment success. The rotation and pull-back mechanism may, for example, advantageously reduce fruit damage. The rotation and pull-back mechanism may, for example, advantageously improve harvesting speed.

In some embodiments the fleet management engine 1000 may include cellular communication. The cellular communication may, for example, include a radio module configured to connect to a mobile network. The cellular communication may, for example, include a SIM interface configured to authenticate the device. The cellular communication may, for example, include an antenna configured to transmit data. For example, the cellular communication may be configured to send vehicle status to a remote server. For example, the cellular communication may include a packet-handling circuit configured to prepare data for transmission. The cellular communication may, for example, be configured to maintain long-range connectivity. The cellular communication may, for example, be configured to update firmware remotely. The cellular communication may, for example, advantageously allow fleet operation in wide geographic areas. The cellular communication may, for example, advantageously reduce dependency on proprietary wireless devices.

In some implementations the fleet management engine 1000 may include LoRa communication. The LoRa communication may, for example, include a low-frequency transceiver configured to send packets. The LoRa communication may, for example, include a spreading-factor control configured to adjust transmission robustness. The LoRa communication may, for example, include a long-range antenna configured to extend communication distance.

For example, the LoRa communication may be configured to transmit low-bandwidth operational data. For example, the LoRa communication may include a decoding module configured to interpret long-range signals. The LoRa communication may, for example, be configured to support communication over large farms. The LoRa communication may, for example, advantageously reduce power consumption.

In some embodiments the fleet management engine 1000 may include Sigfox communication. The Sigfox communication may, for example, include an ultra-narrowband transmitter configured to send small messages. The Sigfox communication may, for example, include a baseband processor configured to encode data. The Sigfox communication may, for example, include an uplink interface configured to forward data to cloud servers. For example, the Sigfox communication may be configured to send battery updates. For example, the Sigfox communication may include a downlink module configured to receive small command messages. The Sigfox communication may, for example, be configured to operate with minimal bandwidth. The Sigfox communication may, for example, advantageously extend battery life.

In some implementations the fleet management engine 1000 may include NB-IoT communication. The NB-IoT communication may, for example, include a narrowband modem configured to access cellular infrastructure. The NB-IoT communication may, for example, include an embedded antenna configured for low-power transmission. The NB-IoT communication may, for example, include a communication stack configured for intermittent updates. For example, the NB-IoT communication may be configured to report sensor readings. For example, the NB-IoT communication may include a sleep-cycle scheduler configured to conserve power. The NB-IoT communication may, for example, be configured to provide reliable long-range connectivity. The NB-IoT communication may, for example, advantageously reduce operational costs.

In some embodiments the computer module 700 may include a master-servant architecture. The master-servant architecture may include Wi-Fi communication. The Wi-Fi communication may, for example, include a network module configured to join an access point. The Wi-Fi communication may, for example, include an RF front-end configured to manage signal strength. The Wi-Fi communication may, for example, include a packet processor configured to manage MAC-layer traffic. For example, the Wi-Fi communication may be configured to distribute coordination commands to servant vehicles. For example, the Wi-Fi communication may include an encryption engine configured to secure data. The Wi-Fi communication may, for example, be configured to support high-bandwidth data exchange. The Wi-Fi communication may, for example, advantageously enable real-time video transmission.

In some implementations the master-servant architecture may include BLE communication. The BLE communication may, for example, include a low-energy radio configured to broadcast beacon messages. The BLE communication may, for example, include a pairing module configured to authenticate nodes. The BLE communication may, for example, include a connection manager configured to maintain short-range links. For example, the BLE communication may be configured to transmit proximity data. For example, the BLE communication may include an advertising channel configured to announce presence. The BLE communication may, for example, be configured for low-power operation. The BLE communication may, for example, advantageously extend runtime for battery-powered units.

In some embodiments the master-servant architecture may include a custom RF protocol. The custom RF protocol may, for example, include a discrete-frequency transmitter configured to avoid interference. The custom RF protocol may, for example, include a proprietary encoding scheme configured to ensure compatibility with fleet hardware. The custom RF protocol may, for example, include a dedicated receiver configured to filter unwanted signals. For example, the custom RF protocol may be configured to support long-range communication. For example, the custom RF protocol may include a handshake module configured to synchronize vehicles. The custom RF protocol may, for example, be configured to operate independently of commercial networks. The custom RF protocol may, for example, advantageously enhance communication reliability. The custom RF protocol may, for example, advantageously reduce vulnerability to network outages.

In some embodiments the scissor lift device 360 may include a gripper mechanism. The gripper mechanism may, for example, include a pair of gripping rods configured to close on a fruit. The gripper mechanism may, for example, include a linkage assembly configured to adjust grip width. The gripper mechanism may, for example, include a drive actuator configured to apply gripping force. For example, the gripper mechanism may be configured to pull fruit inward. For example, the gripper mechanism may include a rotation module configured to roll fruit along its surface. The gripper mechanism may, for example, be configured to handle fruit of varying diameters. The gripper mechanism may, for example, be configured to stabilize fruit during transport. The gripper mechanism may, for example, advantageously operate with fewer moving parts. The alternate gripper mechanism may, for example, advantageously improve reliability.

Although an exemplary system has been described with reference to FIGS. 1-10, other implementations may be deployed in other industrial, scientific, medical, commercial, and/or residential applications. The robotic crop harvesting vehicle system may, for example, be employed in food processing and packaging. The robotic crop harvesting vehicle system may, for example, be employed in recycling and waste management. The robotic crop harvesting vehicle system may, for example, be employed in mining and resource extraction.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor.

Computer program products, which may include software, may be stored in a data store tangibly embedded on a storage medium, such as an electronic, magnetic, or rotating storage device, and may be fixed or removable (e.g., SD card, hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as a 9V (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In some aspects, the techniques described herein relate to a robotic crop harvesting vehicle system including: one or more autonomous vehicles, each of the one or more autonomous vehicles including one or more wheels operatively coupled to a bottom portion of the autonomous vehicle and a power source electrically coupled to the autonomous vehicle; one or more robotic crop harvesting arms operatively coupled to a top portion of each of the one or more autonomous vehicles at a distal end of the one or more robotic crop harvesting arms; a multi-axis end effector operatively coupled to a proximal end of the one or more robotic crop harvesting arms; a guideway operatively coupled to the proximal end of the one or more robotic crop harvesting arms and positioned external to the multi-axis end effector; an adjustable flexible tube operatively coupled to the guideway and configured to receive crops from the guideway via gravity; and a container operatively coupled to the adjustable flexible tube and configured to receive crops from the adjustable flexible tube via gravity.

In some aspects, the techniques described herein relate to a robotic crop harvesting vehicle system, further including a height-adjustable stool operatively coupled to the top portion of each of the one or more autonomous vehicles and operatively coupled to the one or more robotic crop harvesting arms, the height-adjustable stool configured to raise or lower the one or more robotic crop harvesting arms during harvesting operations.

In some aspects, the techniques described herein relate to a robotic crop harvesting vehicle system, wherein the height-adjustable stool includes a scissor lift.

In some aspects, the techniques described herein relate to a robotic crop harvesting vehicle system, wherein the multi-axis end effector further includes: a rotating pipe, operatively coupled to a non-rotating pipe by a bearing housing, the rotating pipe configured to be driven by a bevel-gear system including: a first bevel gear fixed to the rotating pipe and a second bevel gear meshed with the first bevel gear at approximately ninety degrees, the second bevel gear including a motor configured to rotate the second bevel gear such that the first bevel gear rotates the rotating pipe, and a linear actuator operatively coupled to the multi-axis end effector configured to actuate a rotating device of the multi-axis end effector to assist detachment of a crop during rotation.

In some aspects, the techniques described herein relate to a robotic crop harvesting vehicle system, wherein the multi-axis end effector further includes a suction mechanism, the suction mechanism including a vacuum pump configured to generate negative pressure

In some aspects, the techniques described herein relate to a robotic crop harvesting vehicle system, wherein the power source includes a solar panel.

In some aspects, the techniques described herein relate to a robotic crop harvesting vehicle system, wherein the container further includes a level-adjusting surface configured to lower as crops accumulate.

In some aspects, the techniques described herein relate to a robotic crop harvesting vehicle system, wherein the container further includes a metal plate, one or more slots, a pogo pin, and one or more protrusions, the one or more slots configured to slidably engage the one or more protrusions during mounting of the container, and the pogo pin configured to compress against the metal plate to establish an electrical connection configured to power container-mounted electronics.

In some aspects, the techniques described herein relate to a robotic crop harvesting vehicle system, wherein the guideway further includes a scissor lift device including a scissor lift configured to direct produce within the guideway.

In some aspects, the techniques described herein relate to a robotic crop harvesting vehicle system, wherein the guideway further includes cushioning disposed along an interior surface of the guideway and a slit formed along a portion of the guideway, the cushioning configured to cushion crops as they enter the guideway and the slit configured to discharge debris or liquid from within the guideway.

In some aspects, the techniques described herein relate to a robotic crop harvesting vehicle system including: one or more autonomous vehicles, each of the one or more autonomous vehicles including one or more wheels operatively coupled to a bottom portion of the autonomous vehicle and a power source electrically coupled to the autonomous vehicle; one or more robotic crop harvesting arms operatively coupled to a top portion of each of the one or more autonomous vehicles at a distal end of the one or more robotic crop harvesting arms; a multi-axis end effector operatively coupled to a proximal end of the one or more robotic crop harvesting arms; a guideway operatively coupled to the proximal end of the one or more robotic crop harvesting arms and positioned external to the multi-axis end effector; an adjustable flexible tube operatively coupled to the guideway and configured to receive crops from the guideway via gravity; and a container operatively coupled to the adjustable flexible tube and configured to receive crops from the adjustable flexible tube via gravity. a computer module including: a data store including a program of instructions; and, a processor operably coupled to the data store such that, when the processor executes the program of instructions, the processor causes operations to be performed to coordinate detachment of produce by the multi-axis end effector to deposit the produce into the guideway and into the container.

In some aspects, the techniques described herein relate to a robotic crop harvesting vehicle system, further including a camera operatively coupled to the multi-axis end effector and communicably coupled to the computer module, wherein the camera is configured to transmit a signal indicating detection of a crop to be harvested to the computer module and, wherein the operations of the computer module further include: retrieve image data from the camera; determine a motion profile for the robotic crop harvesting arm; compute forward kinematics and inverse kinematics to position and orient the multi-axis end effector; generate commands to move the robotic crop harvesting arm to a location of the crop; generate an activation command to grasp the crop; determine whether the crop is successfully grasped; when the crop is not successfully grasped, generate adjustments to a grasping device of the multi-axis end effector; and, update a harvesting policy based on error feedback, such that the computer module coordinates detection, approach, grasp, and adaptive correction to deposit the crop into the guideway and into the container.

In some aspects, the techniques described herein relate to a robotic crop harvesting vehicle system, further including one or more infrared sensors operatively coupled to the guideway and communicably coupled to the computer module, wherein the one or more infrared sensors are configured to transmit a signal indicating detection of a crop entering the guideway to the computer module.

In some aspects, the techniques described herein relate to a robotic crop harvesting vehicle system, further including one or more seismic sensors operatively coupled to the guideway and communicably coupled to the computer module, wherein the seismic sensors are configured to transmit a signal to the computer module indicating movement and impact of a crop traveling through the guideway.

In some aspects, the techniques described herein relate to a robotic crop harvesting vehicle system, wherein the container further includes a level-adjusting surface and a proximity sensor operatively coupled to a bottom portion of the container below the level-adjusting surface, wherein the proximity sensor is communicably coupled to the computer module, such that the proximity sensor is configured to transmit a signal indicating detection that the level-adjusting surface of the container has reached a lower position of the container.

In some aspects, the techniques described herein relate to a robotic crop harvesting vehicle system, furthering including a global positioning system (GPS) communicably coupled to the computer module and one or more sensors communicably coupled to the computer module, wherein the operations include: retrieve initialization data to initialize the autonomous vehicle system; retrieve GPS data to navigate the autonomous vehicle toward a crop location; retrieve sensor readings from one or more sensors; generate a state of the autonomous vehicle using a deep reinforcement learning agent based on the retrieved sensor readings; determine a navigation action based on a state of the autonomous vehicle using a deep reinforcement learning agent; generate a movement command to cause the autonomous vehicle to execute the navigation action; retrieve sensor readings from the one or more sensors including environmental feedback based on execution of the navigation action; determine a harvesting action to be performed by the multi-axis end effector based on a fusion of one or more sensor readings of the one or more sensors; generate one or more harvesting commands to detach a crop and deposit the crop into the guideway; retrieve container-level information indicating whether the container is full; and generate a return-to-storage command when the container is full, such that the autonomous vehicle navigates toward crops, avoids obstacles, coordinates harvesting operations, and returns to a storage location when the container has reached capacity.

In some aspects, the techniques described herein relate to a robotic crop harvesting vehicle system, wherein the operations include: (a) retrieve historical data including environmental and contextual data and qualitative sensor data; (b) determine a division of the retrieved data into a first set used for training and a second set used for testing; (c) apply a model, using the deep reinforcement learning engine, to the training set and generate a trained model; (d) apply the trained model to the testing set and generate test outputs; (e) determine whether the trained model satisfies a predetermined training criterion; (f) when the predetermined training criterion is not satisfied, generate a request for additional training data and repeat application of the trained model to the testing set; (g) when the predetermined training criterion is satisfied, generate a storage action to store the trained model; (h) monitor the system for a model-update trigger; (i) determine that the model-update trigger has been detected; and (j) repeat steps (a)-(i), such that the computer module iteratively trains, evaluates, and updates to improve detection, navigation, and harvesting performance.

In some aspects, the techniques described herein relate to a robotic crop harvesting vehicle system, wherein the operations include: retrieve vehicle status data from the one or more robotic crop harvesting vehicles; determine fleet-level coordination decisions using a fleet management engine; and generate communication directives for the one or more robotic crop harvesting vehicles based on the fleet-level coordination decisions, such that the one or more robotic crop harvesting vehicles operate cooperatively under common task assignments and coordinated navigation instructions.

In some aspects, the techniques described herein relate to a robotic crop harvesting vehicle system, wherein the operations include: retrieve outbound status messages transmission from an external communication device; determine navigation instructions based on the retrieved messages received by the external communication device; and generate control signals for the one or more autonomous vehicles based on the navigation instructions, such that the robotic crop harvesting vehicle system communicates with the external communication device to enable remote monitoring and remote instruction of the one or more autonomous vehicles.

In some aspects, the techniques described herein relate to a robotic crop harvesting vehicle system, wherein the external communication device includes satellite systems.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A robotic crop harvesting vehicle system comprising:
one or more autonomous vehicles, each of the one or more autonomous vehicles comprising one or more wheels operatively coupled to a bottom portion of the autonomous vehicle and a power source electrically coupled to the autonomous vehicle;
one or more robotic crop harvesting arms operatively coupled to a top portion of each of the one or more autonomous vehicles at a distal end of the one or more robotic crop harvesting arms;
a multi-axis end effector operatively coupled to a proximal end of the one or more robotic crop harvesting arms;
a guideway operatively coupled to the proximal end of the one or more robotic crop harvesting arms and positioned external to the multi-axis end effector;
an adjustable flexible tube operatively coupled to the guideway and configured to receive crops from the guideway via gravity; and
a container operatively coupled to the adjustable flexible tube and configured to receive crops from the adjustable flexible tube via gravity.

2. The robotic crop harvesting vehicle system of claim 1, further comprising a height-adjustable stool operatively coupled to the top portion of each of the one or more autonomous vehicles and operatively coupled to the one or more robotic crop harvesting arms, the height-adjustable stool configured to raise or lower the one or more robotic crop harvesting arms during harvesting operations.

3. The robotic crop harvesting vehicle system of claim 2, wherein the height-adjustable stool comprises a scissor lift.

4. The robotic crop harvesting vehicle system of claim 1, wherein the multi-axis end effector further comprises:
a rotating pipe, operatively coupled to a non-rotating pipe by a bearing housing, the rotating pipe configured to be driven by a bevel-gear system comprising:
a first bevel gear fixed to the rotating pipe and a second bevel gear meshed with the first bevel gear at approximately ninety degrees, the second bevel gear comprising a motor configured to rotate the second bevel gear such that the first bevel gear rotates the rotating pipe, and a linear actuator operatively coupled to the multi-axis end effector configured to actuate a rotating device of the multi-axis end effector to assist detachment of a crop during rotation.

5. The robotic crop harvesting vehicle system of claim 1, wherein the multi-axis end effector further comprises a suction mechanism, the suction mechanism comprising a vacuum pump configured to generate negative pressure

6. The robotic crop harvesting vehicle system of claim 1, wherein the power source comprises a solar panel.

7. The robotic crop harvesting vehicle system of claim 1, wherein the container further comprises a level-adjusting surface configured to lower as crops accumulate.

8. The robotic crop harvesting vehicle system of claim 1, wherein the container further comprises a metal plate, one or more slots, a pogo pin, and one or more protrusions, the one or more slots configured to slidably engage the one or more protrusions during mounting of the container, and the pogo pin configured to compress against the metal plate to establish an electrical connection configured to power container-mounted electronics.

9. The robotic crop harvesting vehicle system of claim 1, wherein the guideway further comprises a scissor lift device comprising a scissor lift configured to direct produce within the guideway.

10. The robotic crop harvesting vehicle system of claim 1, wherein the guideway further comprises cushioning disposed along an interior surface of the guideway and a slit formed along a portion of the guideway, the cushioning configured to cushion crops as they enter the guideway and the slit configured to discharge debris or liquid from within the guideway.

11. A robotic crop harvesting vehicle system comprising:
one or more autonomous vehicles, each of the one or more autonomous vehicles comprising one or more wheels operatively coupled to a bottom portion of the autonomous vehicle and a power source electrically coupled to the autonomous vehicle;
one or more robotic crop harvesting arms operatively coupled to a top portion of each of the one or more autonomous vehicles at a distal end of the one or more robotic crop harvesting arms;
a multi-axis end effector operatively coupled to a proximal end of the one or more robotic crop harvesting arms;
a guideway operatively coupled to the proximal end of the one or more robotic crop harvesting arms and positioned external to the multi-axis end effector;
an adjustable flexible tube operatively coupled to the guideway and configured to receive crops from the guideway via gravity; and
a container operatively coupled to the adjustable flexible tube and configured to receive crops from the adjustable flexible tube via gravity. a computer module comprising:
a data store comprising a program of instructions; and,
a processor operably coupled to the data store such that, when the processor executes the program of instructions, the processor causes operations to be performed to coordinate detachment of produce by the multi-axis end effector to deposit the produce into the guideway and into the container.

12. The robotic crop harvesting vehicle system of claim 11, further comprising a camera operatively coupled to the multi-axis end effector and communicably coupled to the computer module, wherein the camera is configured to transmit a signal indicating detection of a crop to be harvested to the computer module and, wherein the operations of the computer module further comprise:
retrieve image data from the camera;
determine a motion profile for the robotic crop harvesting arm;
compute forward kinematics and inverse kinematics to position and orient the multi-axis end effector;
generate commands to move the robotic crop harvesting arm to a location of the crop;
generate an activation command to grasp the crop;
determine whether the crop is successfully grasped;
when the crop is not successfully grasped, generate adjustments to a grasping device of the multi-axis end effector; and,
update a harvesting policy based on error feedback,
such that the computer module coordinates detection, approach, grasp, and adaptive correction to deposit the crop into the guideway and into the container.

13. The robotic crop harvesting vehicle system of claim 11, further comprising one or more infrared sensors operatively coupled to the guideway and communicably coupled to the computer module, wherein the one or more infrared sensors are configured to transmit a signal indicating detection of a crop entering the guideway to the computer module.

14. The robotic crop harvesting vehicle system of claim 11, further comprising one or more seismic sensors operatively coupled to the guideway and communicably coupled to the computer module, wherein the seismic sensors are configured to transmit a signal to the computer module indicating movement and impact of a crop traveling through the guideway.

15. The robotic crop harvesting vehicle system of claim 11, wherein the container further comprises a level-adjusting surface and a proximity sensor operatively coupled to a bottom portion of the container below the level-adjusting surface, wherein the proximity sensor is communicably coupled to the computer module, such that the proximity sensor is configured to transmit a signal indicating detection that the level-adjusting surface of the container has reached a lower position of the container.

16. The robotic crop harvesting vehicle system of claim 11, furthering comprising a global positioning system (GPS) communicably coupled to the computer module and one or more sensors communicably coupled to the computer module, wherein the operations comprise:
retrieve initialization data to initialize the autonomous vehicle system;
retrieve GPS data to navigate the autonomous vehicle toward a crop location;
retrieve sensor readings from one or more sensors;
generate a state of the autonomous vehicle using a deep reinforcement learning agent based on the retrieved sensor readings;
determine a navigation action based on a state of the autonomous vehicle using a deep reinforcement learning agent;
generate a movement command to cause the autonomous vehicle to execute the navigation action;
retrieve sensor readings from the one or more sensors comprising environmental feedback based on execution of the navigation action;
determine a harvesting action to be performed by the multi-axis end effector based on a fusion of one or more sensor readings of the one or more sensors;
generate one or more harvesting commands to detach a crop and deposit the crop into the guideway;
retrieve container-level information indicating whether the container is full; and
generate a return-to-storage command when the container is full, such that the autonomous vehicle navigates toward crops, avoids obstacles, coordinates harvesting operations, and returns to a storage location when the container has reached capacity.

17. The robotic crop harvesting vehicle system of claim 16, wherein the operations comprise:
(a) retrieve historical data comprising environmental and contextual data and qualitative sensor data;
(b) determine a division of the retrieved data into a first set used for training and a second set used for testing;
(c) apply a model, using the deep reinforcement learning engine, to the training set and generate a trained model;
(d) apply the trained model to the testing set and generate test outputs;
(e) determine whether the trained model satisfies a predetermined training criterion;
(f) when the predetermined training criterion is not satisfied, generate a request for additional training data and repeat application of the trained model to the testing set;
(g) when the predetermined training criterion is satisfied, generate a storage action to store the trained model;
(h) monitor the system for a model-update trigger;
(i) determine that the model-update trigger has been detected; and
(j) repeat steps (a)-(i), such that the computer module iteratively trains, evaluates, and updates to improve detection, navigation, and harvesting performance.

18. The robotic crop harvesting vehicle system of claim 11, wherein the operations comprise:
retrieve vehicle status data from the one or more robotic crop harvesting vehicles;
determine fleet-level coordination decisions using a fleet management engine; and
generate communication directives for the one or more robotic crop harvesting vehicles based on the fleet-level coordination decisions, such that the one or more robotic crop harvesting vehicles operate cooperatively under common task assignments and coordinated navigation instructions.

19. The robotic crop harvesting vehicle system of claim 11, wherein the operations comprise:
retrieve outbound status messages transmission from an external communication device;
determine navigation instructions based on the retrieved messages received by the external communication device; and
generate control signals for the one or more autonomous vehicles based on the navigation instructions, such that the robotic crop harvesting vehicle system communicates with the external communication device to enable remote monitoring and remote instruction of the one or more autonomous vehicles.

20. The robotic crop harvesting vehicle system of claim 19, wherein the external communication device comprises satellite systems.

21. The robotic crop harvesting vehicle system of claim 11, wherein the computer module is further configured to execute an end-effector-centric training deployment workflow comprising:
simulating a robotic manipulator in a virtual environment during a training phase;
applying deep reinforcement learning using rewards based on successful end-effector task execution;
recording joint-encoder values corresponding to successful end-effector positions and orientations;
training a supervised neural network to map desired end-effector poses to corresponding joint-encoder values;
during deployment of the trained neural network, receiving crop-location data from a vision system;
determining a desired end-effector pose based on the crop-location data;
providing the desired end-effector pose as input to the trained neural network;
receiving, from the trained neural network, predicted joint-encoder values; and
actuating the robotic manipulator based on the predicted joint-encoder values to enable real-time crop harvesting.
